(19) United States
(12) Patent Application Publication
(10) Pub. No.: US 2024/0137691 A1
(43) Pub. Date: Apr. 25, 2024

(54) FRONT CENTER VEHICLE CONSOLE WITH SPEAKERS, AND VEHICLE COMPRISING SAME

(71) Applicant: SUZHOU SONAVOX ELECTRONICS CO., LTD., Suzhou, Jiangsu (CN)

(72) Inventors: Marc-Olivier CHAUVEAU, TOURS (FR); Marc LEVASSEUR, TOURS (FR)

(21) Appl. No.: 18/546,957

(22) PCT Filed: Feb. 16, 2022
(86) PCT No.: PCT/EP2022/053821

§ 371 Date: Aug. 16, 2023

(30) Foreign Application Priority Data
Feb. 18, 2021 (FR) 2101602

(51) Int. Cl. H04R 1/22; B60R 11/02; H04R 1/02; H04R 1/28; H04R 5/02; H04S 3/00; H04S 7/00

(52) U.S. Cl. CPC H04R 1/227; B60R 11/0217; H04R 1/025; H04R 1/288; H04R 5/02; H04S 3/008; H04S 7/307; B60R 2011/0007

(57) ABSTRACT

Disclosed are a vehicle having a device for reproducing sound and a vehicle center console. The vehicle includes a device for reproducing sound by loudspeakers, including a single enclosure being installed in the center console of the vehicle. The enclosure includes two opposite ends and, internally, a pair of loudspeakers. The two loudspeakers are arranged face to face or back to back at the two opposite ends of the enclosure. The device for reproducing sound is installed in the front median space between the driver seat and the front passenger seat, and the two front side walls of the passenger compartment do not include a sound reproduction element for the low-frequency spectrum.

### TECHNICAL FIELD

The present disclosure relates generally to the field of automotive audio, and more particularly to a vehicle having a device for reproducing sound arranged in a front median space of a passenger compartment of the vehicle, i.e., at the front part of the passenger compartment. The present disclosure relates to a device for reproducing sound. The present disclosure can be applied to produce an automotive audio enclosure and an automotive audio device.

### BACKGROUND

In the field of low-frequency reproduction (also known as bass reproduction) for reproducing the human audible audio/sound spectrum, generally below 200 Hz, it is known and advantageous to use an enclosure including loudspeakers arranged in pairs and opposite to each other along the axis of the enclosure. In particular, this arrangement allows reducing vibrations of the enclosure. As examples, the following documents can be cited: WO 2020 129 262, WO 2009 130 778, WO 91 16 798, FR 2 373 936, and U.S. Pat. No. 2,004,017 920. Documents JP 2010 215074 A, WO 2016/123360 A1, EP 1 558 056 A1, and FR 2 627 341 A1 may also be cited.

Such enclosures have been used to sound in car interiors.

In addition, audio systems used in vehicles include multiple channels of sound reproduction, including left and right channels for the stereo. However, the ability of human to spatialize the audio sources is not as effective as high frequencies in the case of low-frequency reproduction.

The applicant believes that placing a subwoofer on one side of a person, compared to placing loudspeakers on the right and left sides of the person, fundamentally does not harm the subjective quality of the received sound because the loudspeaker is installed in the passenger compartment of the vehicle.

The applicant suggests to install a subwoofer in the front median space of the passenger compartment of the vehicle, which is located between a driver seat and a front passenger seat and usually along the median longitudinal axis or sagittal axis of the vehicle, and two subwoofers usually arranged in the two front side walls, in two front doors of the vehicle are removed.

### SUMMARY

More specifically, the applicant provides by means of the present disclosure a vehicle, comprising, in a passenger compartment of the vehicle, a device for reproducing sound by loudspeakers, wherein the passenger compartment comprises seats of which, at the front of the passenger compartment, between two front side walls of the passenger compartment, a driver seat and a front passenger seat separated by a front median space comprising a vehicle center console, the reproducing sound of the device for reproducing sound covers a low-frequency spectrum in an audible spectrum to a human; the device for reproducing sound comprises a single enclosure and being installed in the center console of the vehicle; the enclosure comprises two opposite ends and, internally, a pair of loudspeakers; each of the loudspeakers comprises two opposite front and rear sides, with a face on the front side and a back on the rear side; the two loudspeakers of the enclosure are identical and are arranged on a same axis of the enclosure, symmetrically with respect to a transverse median plane of the enclosure perpendicular to the axis of the enclosure; the two loudspeakers are arranged face to face or back to back at the two opposite ends of the enclosure; the device for reproducing sound is installed in the front median space between the driver seat and the front passenger seat, and the two front side walls of the passenger compartment do not comprise a sound reproduction element for the low-frequency spectrum. Other non-limiting and advantageous features of the vehicle according to the disclosure are as follows, and these features can be used alone or in combination according to any feasible technical combination:
the vehicle also comprises one or more devices for reproducing sound according to the disclosure, but they are arranged elsewhere than the front median space,
the passenger compartment includes a floor, and the device for reproducing sound by the loudspeakers is placed on the floor,
the passenger compartment is surmounted by a roof, and the device for reproducing sound by the loudspeakers is installed under and positioned against the roof,
the enclosure is powered by an audio electrical signal,
a pair of loudspeakers of the enclosure of the device for reproducing sound is powered by an audio electrical signal,
the device for reproducing sound is powered by an audio electrical signal,
the enclosure of the device for reproducing sound is closed and hollow inside and comprising two openings at the two opposite ends thereof, the two loudspeakers are arranged against the openings,
the enclosure of the device for reproducing sound is enclosed and hollow inside and comprising two openings at the two opposite ends thereof, the two loudspeakers are arranged against the openings, outside the enclosure,
each loudspeaker includes a membrane on the front side,
each loudspeaker includes a basket or chassis on the rear side,
the loudspeakers are electrodynamic loudspeakers,
the audio electrical signal of the device for reproducing sound is composed of left and right signals of a stereo audio system,
the low-frequency spectrum has a high cut-off frequency, at −3 dB, specific to the device for reproducing sound, of 400 Hz,
the low-frequency spectrum has a high cut-off frequency, at −3 dB, specific to the device for reproducing sound, up to 400 Hz,
advantageously, the low-frequency spectrum has a high cut-off frequency, at −3 dB, specific to the device for reproducing sound, which is 200 Hz,
more advantageously, the low-frequency spectrum has a high cut-off frequency, at −3 dB, specific to the device for reproducing sound, which is 150 Hz,
preferably, the low-frequency spectrum has a high cut-off frequency, at −3 dB, specific to the device for reproducing sound, which is 100 Hz,
at least one passive filter is mounted in the enclosure, and the pair of loudspeakers is powered by an audio electrical signal through the at least one passive filter,
the passive filter is a low-pass inductive filter,
the passive filter is a low-pass LC filter,
the passive filter is a low-pass RLC filter,
the passive filter is a band-pass inductive filter,
the passive filter is a band-pass LC filter,
the passive filter is a band-pass RLC filter,
the vehicle includes a multi-channel audio electronic device, comprising an audio power amplifier assembly producing an audio electrical signal, the audio power amplifier producing an audio electrical signal is intended for the device for reproducing sound to receive from upstream an audio signal to be amplified, which has been filtered by a low-pass or band-pass filter of the multi-channel audio electronic device,
the low-pass or band-pass filter of the multi-channel audio electronic device is of an active analog and/or a digital type,
the multi-channel audio electronic device is a vehicle radio,
the device for reproducing sound includes at least one terminal assembly consisting, at an output end, of an audio power amplifier and, at an input end, of a low-pass or band-pass filter, the input end receives the audio electrical signal to be amplified, and the output end is connected to at least one enclosure of the device for reproducing sound; the device for reproducing sound also receives a power supply,
the terminal assembly is arranged in the enclosure,
the low-pass or band-pass filter of the terminal assembly consisting of the audio power amplifier and the low-pass or band-pass filter is analog and/or digital active,
the terminal assembly consisting of the audio power amplifier and the low-pass or band-pass filter is arranged in the device for reproducing sound,
the terminal assembly consisting of the audio power amplifier and the low-pass or band-pass filter is arranged in the enclosure,
the low-pass or band-pass filter of the multi-channel audio electronic device or the terminal assembly has a high cut-off frequency, at −3 dB, of 400 Hz,
the low-pass or band-pass filter of the multi-channel audio electronic device or the terminal assembly has a high cut-off frequency, at −3 dB, up to 400 Hz,
advantageously, the low-pass or band-pass filter of the multi-channel audio electronic device or the terminal assembly has a high cut-off frequency, at −3 dB, of 200 Hz,
more advantageously, the low-pass or band-pass filter of the multi-channel audio electronic device or the terminal assembly has a high cut-off frequency, at −3 dB, of 150 Hz,
preferably, the low-pass or band-pass filter of the multi-channel audio electronic device or the terminal assembly has a high cut-off frequency, at −3 dB, of 100 Hz,
the two loudspeakers are electrically connected such that their membranes vibrate in phase and move in anti-parallel,
the two loudspeakers are electrically connected so that their membranes vibrate in phase opposition and move in parallel,
the enclosure is specifically configured to be installed horizontally in the front median space between the driver seat and the front passenger seat, and the axis of the enclosure is horizontal,
the front median space includes the floor and the enclosure is specifically configured to be mounted vertically in the front median space between the driver seat and the front passenger seat, the axis of the enclosure is vertical, and a free space is arranged between the floor of the front median space and the enclosure,
the enclosure is specifically configured to be mounted horizontally with its axis longitudinally oriented, between the front and rear of the vehicle,
the enclosure is specifically configured to be mounted horizontally with its axis transversely oriented, towards the driver seat and the front passenger seat,
the enclosure is specifically configured to be mounted horizontally without extending to its opposite ends under the driver seat and the front passenger seat,
the enclosure is specifically configured to be mounted horizontally, extending to its two opposite ends under the driver seat and the front passenger seat,
the enclosure is in one piece,
the enclosure includes a shell,
the enclosure is in one piece or assembled from parts of the enclosure,
the enclosure is assembled from enclosure sections,
the enclosure is constructed by assembling at least two enclosure sections,
the enclosure sections include end sections for attaching the loudspeakers and a midsection,
the device for reproducing sound includes a single enclosure, the axis of which can be oriented transversely or longitudinally or vertically,
the single-enclosure device for reproducing sound is mounted on a vehicle center console,
the single-enclosure device for reproducing sound is shaped as a part of the vehicle center console,
the single-enclosure device for reproducing sound is shaped as a part of the vehicle center console, preferably the rear part of the center console,
the single-enclosure device for reproducing sound is shaped as a vehicle center console,
the device for reproducing sound includes one to four enclosures,
the device for reproducing sound includes one enclosure,
the device for reproducing sound includes a plurality of enclosures,
the device for reproducing sound with several enclosures is in one piece,
the device for reproducing sound with several enclosures is compact,
the device for reproducing sound with several enclosures is mounted in the center console of the vehicle,
the device for reproducing sound with several enclosures is shaped as a part of the center console of the vehicle,
the device for reproducing sound with several enclosures is shaped as a part of the center console of the vehicle, preferably the rear part of the center console,
the device for reproducing sound with several enclosures is shaped as a center console of the vehicle,
the device for reproducing sound includes two enclosures,
the device for reproducing sound includes two enclosures, the enclosure axis of a first enclosure is oriented transversely, and the enclosure axis of a second enclosure is oriented longitudinally,
the device for reproducing sound includes two enclosures, the enclosure axis of a first enclosure is oriented transversely, and the enclosure axis of a second enclosure is oriented vertically,
the device for reproducing sound includes two enclosures, the enclosure axis of a first enclosure is oriented longitudinally, and the enclosure axis of a second enclosure is oriented vertically,
the device for reproducing sound includes three enclosures,
the device for reproducing sound includes three enclosures, the enclosure axis of a first enclosure is oriented transversely, the enclosure axis of a second enclosure is oriented longitudinally, and the enclosure axis of a third enclosure is oriented vertically,
the device for reproducing sound includes four enclosures,
the shape of the enclosure is selected from cylindrical and right prism shapes, including cube or rectangular parallelepiped,
in a case of a enclosure having a cylindrical shape, the cross-section of the enclosure is circular,
in a case of a enclosure having the shape of a right prism, including a cube or a rectangular parallelepiped, the cross-section of the enclosure is square,
the volume of the enclosure is between 0.5 L and 5 L,
the volume of the enclosure is less than 4 L,
advantageously, the volume of the enclosure is between 1 L and 4 L,
the front side of each loudspeaker includes a membrane which is circular,
each loudspeaker comprises a membrane which is elliptical or ova on the front side, and the cross section of the enclosure is elliptical or ova,
in special cases, the volume of the enclosure is about 3 L,
in special cases, the front side of each loudspeaker includes a circular membrane with a diameter of 13 cm,
the enclosure comprises spacers or stiffening tie rods parallel to the axis of the enclosure,
the enclosure comprises spacers or stiffening tie rods perpendicular to the axis of the enclosure
the enclosure includes spacers or stiffening rods extending between the loudspeakers,
the enclosure includes a transverse median panel on the inside perpendicular to the axis of the enclosure, and the transverse median panel is equidistant from the two loudspeakers.
the transverse median panel is closed and defines two interior spaces of roughly equal volume in the enclosure together with the two loudspeakers,
there is no transverse median panel inside the enclosure,
the enclosure includes walls that are substantially rigid,
the enclosure includes walls of a plastic material,
the enclosure includes walls of a wood material,
the interior of the enclosure includes a sound-absorbing material, especially a fibrous and/or porous foam material,
the enclosure includes two grilles, closing the two opposite ends of the enclosure,
the enclosure is closed and has the internal volume pneumatically isolated from the outside,
the enclosure includes at least one vent connected to the internal volume,
the vehicle is a personal or commercial vehicle,
the passenger compartment is the passenger compartment of a personal or commercial vehicle, or the passenger compartment of a truck, and/or additionally,
the vehicle includes loudspeakers other than those of the device for reproducing sound of the present disclosure,
the other loudspeakers are intended to reproduce a high-frequency spectrum,
the other loudspeakers are intended to reproduce a medium-frequency spectrum,
the other loudspeakers are intended to reproduce a low-frequency spectrum,
the other loudspeakers are intended to reproduce a frequency spectrum on a mixed band of low and medium frequencies,
the other loudspeakers are intended to reproduce a frequency spectrum on a mixed band of medium and high frequencies,
the other loudspeakers are intended to reproduce a frequency spectrum on a mixed band of low, medium and high frequencies,
at least one other loudspeaker is arranged in the front median space,
the other loudspeakers are arranged elsewhere than the front median space.

The present disclosure also relates to a device for reproducing sound by loudspeakers for a vehicle passenger compartment, the reproducing sound covers a low-frequency spectrum in an audible spectrum to human, the passenger compartment includes seats, including, in the front of the passenger compartment and between two front side walls, a driver seat and a front passenger seat separated by a front median space; the device for reproducing sound includes at least one enclosure, the enclosure has two opposite ends and also include a pair of loudspeakers inside, each of the loudspeakers includes two opposite front and rear parts, with a face on the front side and a back on the rear side; the two loudspeakers of the enclosure are identical and are arranged on a same axis of the enclosure and symmetrical with respect to a transverse median plane of the enclosure perpendicular to the axis of the enclosure; the two loudspeakers are arranged face to face or back to back at the two opposite ends of the enclosure; the device for reproducing sound is specifically configured to be mounted in the front median space between the driver seat and the front passenger seat, thus obtaining the vehicle. The present disclosure finally relates to a method for installing a device for reproducing sound for reproducing a low-frequency spectrum through loudspeakers in the passenger compartment of a vehicle. In this method, the device for reproducing sound is mounted in a median space between a driver seat and a front passenger seat, and no element for reproducing sound in low-frequency spectrum is mounted in the two front side walls.

### BRIEF DESCRIPTION OF DRAWINGS

FIG. 1 is a schematic diagram of a cylindrical enclosure, having a pair of loudspeakers arranged back to back;

FIG. 2 is a schematic diagram of a cylindrical enclosure, having a pair of loudspeakers arranged face to face;

FIG. 3 is a schematic diagram of a cylindrical enclosure, having a pair of loudspeakers arranged back to back, wherein the enclosure internally comprises a transverse median panel perpendicular to the axis of the enclosure and dividing the internal load space of the enclosure into two parts;

FIG. 4 is a schematic diagram of a cubic loudspeaker, comprising a pair of loudspeakers arranged back to back, where the enclosure comprises stiffening spacers extended between the two loudspeakers and shaped into columns;

FIG. 5 is a semi-plunging, transparent view of a vehicle interior comprising, a driver seat and a front passenger seat that are separated by a front median space between two front side walls, and a device for reproducing sound comprising an enclosure installed vertically on the floor in the front median space;

FIG. 6 is a top, transparent view of a vehicle interior comprising, a driver seat and a front passenger seat that are separated by a front median space between two front side walls, and a device for reproducing sound including an enclosure installed horizontally and transversely on the floor in the front median space;

FIG. 7 is a front, transparent view of the passenger compartment in FIG. 6; and

FIG. 8 shows measurements of the audio/acoustic response of a device for reproducing sound, where the device for reproducing sound includes an enclosure arranged in the front median space, the measurements being carried out, on the one hand, at the driver's position in the passenger compartment and on the other hand in semi-anechoic condition, and in the both cases no “equalization”/compensation being implemented.

### DETAILED DESCRIPTION OF PREFERRED EMBODIMENTS

The following description with reference to the accompanying drawings, given by way of non-limiting examples, will make it clear what the disclosure consists of and how it can be implemented.

In principle, the present disclosure relates to a device for reproducing sound by loudspeakers, comprising at least one compact enclosure. The enclosure includes a pair of loudspeakers arranged in push-push and intended to reproduce low frequencies in a vehicle interior. The device for reproducing sound allows better coupling with the acoustics of the passenger compartment, in particular with excitation of the modes and distribution of sound pressure uniformly throughout the passenger compartment, a reduction in vibrations generated by the operation of the loudspeakers and a greater compactness compared to conventional solutions. The solution provided here also makes it possible to have no woofer in the doors.

Each enclosure of the device for reproducing sound uses two loudspeakers positioned back to back or face to face to eliminate vibrations caused by their operation. The device for reproducing sound is positioned at the front of the vehicle, in the median part, between the front seats, especially in the center console, especially in the part arranged between the front seats.

Advantageously, the two loudspeakers of each enclosure emit sound in a width direction of the vehicle, that is, the axis of the enclosure is transverse. This positioning and push-push operation allow optimum acoustic coupling with the passenger compartment and in particular a reduction in the excitation of the natural acoustic modes of the passenger compartment. In addition, the sound source is closer to a listener than a conventional woofer located, for example, in the trunk of a vehicle. An extension of the bandwidth in the low frequency and a uniform distribution of sound pressure throughout the vehicle are achieved. Therefore, it is possible to completely dispense with subwoofers. In some embodiments, however, one or more additional woofers may be located elsewhere than in the doors and the front median part, and installed, for example, in the trunk of the vehicle or under the vehicle seats.

In a variant, the two loudspeakers of each enclosure emit sound in a length direction of the vehicle, that is, the axis of the enclosure is longitudinal. In another variant, the two loudspeakers of each enclosure emit sound in a height direction of the vehicle, that is, the axis of the enclosure is vertical. According to the device for reproducing sound of the present disclosure, the two loudspeakers of each enclosure are loaded by a reduced volume, which makes the device for reproducing sound as compact as possible. The volume of each enclosure may have a different shape depending on the embodiment. The volume of each enclosure allows the two loudspeakers to be used mainly around and below resonant frequencies of the two loudspeakers (in load), and the load volume can be shared by both loudspeakers or separated by a transverse median panel inside the enclosure.

To this end, for example, loudspeakers with a resonant frequency in the open air of 60 Hz are used, and both loudspeakers have a enclosure volume of less than 4 L. The loudspeaker of this volume has a resonant frequency of around 90-100 Hz, or even a little higher. The high cut-off frequency at −3 dB of the low-pass or band-pass filter of the signal sent to the loudspeaker is higher and is preferably between 100 HZ and 400 Hz, more preferably between 100 HZ and 150 Hz. Therefore, the loudspeaker is mainly used under the resonant frequency in the enclosure.

In practice, the volume of the loudspeaker may vary from 0.5 L to 5 L, usually around 3 L to 4 L.

Also as an example, a loudspeaker with a diameter of 13 cm and a resonant frequency in the open air of 60 Hz (Vas=2.65 L) may be used, and two loudspeakers have a load volume of 3.7 L in total, i.e., 1.85 L per loudspeaker. The resonant frequency of the loudspeaker in the enclosure is 93 Hz, the cut-off frequency of the filtered signal sent to the loudspeaker is 100 Hz, and a digital filter is used.

In another example, a loudspeaker with a diameter of 10 cm and a resonant frequency in the open air of 65 Hz (Vas=1.9 L) may be used, and two loudspeakers have a load volume of 2.8 L in total, i.e., 1.4 L per loudspeaker. The resonant frequency of the loudspeaker in the enclosure is 100 Hz, the cut-off frequency of the filtered signal sent to the loudspeaker is 120 Hz, and a digital filter is also used.

It will be understood that the present disclosure may be implemented with loudspeakers, loudspeaker volumes and different signal filtering, for which the resonant frequency F_{C} in the space VB enclosed by a case or a enclosure may be calculated as follows:

F_{C}=F_{S}*(V_{AS}/V_{B}+1)^{0.5}

where V_{AS}=c²*Rₒ*C_{MS}*S_{d}², where C_{MS}=suspension flexibility of the loudspeaker, S_{d}=emissive surface of the loudspeaker, sound velocity c is typically 343.707 m/s and air density Rₒ is typically 1.2 Kg/m3. This equation corresponds to a loudspeaker in an enclosure, and thus to a half of the enclosure of the present disclosure.

In the figures, the illustrated loudspeaker has walls presented, and additional elements of the enclosure, such as grilles on the openings or the loudspeaker, internal quilting, one or more internal passive filters, electrical connection wires and/or connectors are not presented. Furthermore, it will be understood that the enclosure may be integrated into components of the passenger compartment, particularly a part of or the entire vehicle center console, and that the resulting shape including the enclosure may be relatively complex. The walls of the enclosure that form a shell are rigid and usually made of a plastic material. In order to actually make the enclosure, it can be assembled from two half-enclosures, for example, two half-enclosures are rigidly assembled and fixed, with sufficient airtightness. More than two enclosure sections may be used, including, for example, two enclosure end sections for fixing the loudspeakers, and one or more enclosure midsections between the two enclosure end sections, in order to produce a more or less slender enclosure. The midsection may include specific components such as a transverse median panel, one/two passive filters, an audio amplifier, a connector on the outside, etc.

The enclosure itself has a relatively simple overall shape, either cylindrical or straight prism shape, defining an internal load volume. The two loudspeakers of a pair of enclosure are arranged parallel to each other at opposite ends of the load volume, along the axis of the enclosure and at openings of the enclosure, and the openings are enclosed by grilles to protect the membrane of each loudspeaker.

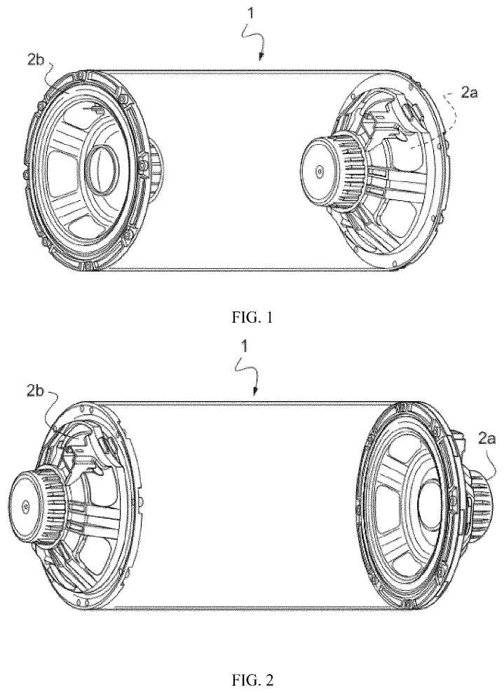

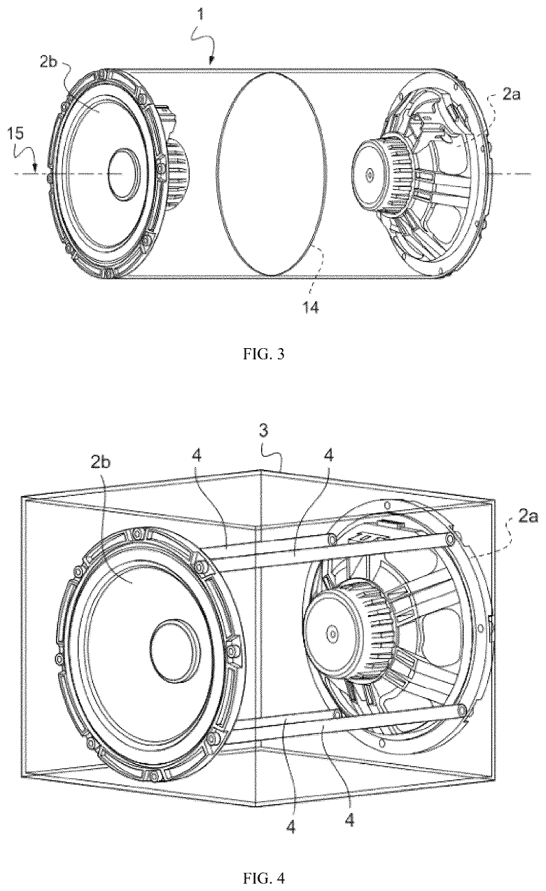

In FIG. 1, the two loudspeakers 2a and 2b of the enclosure 1 are circular and arranged back to back, and the illustrated enclosure 1 is shaped as a cylinder, defining a hollow cylindrical load volume within the enclosure. The loudspeakers are fixed on the inside the enclosure and aligned along the axis 15 of the enclosure (see FIG. 3).

In FIG. 2, the two loudspeakers 2a and 2b of the enclosure 1 are circular and arranged face to face, and the illustrated enclosure 1 is shaped as a cylinder, defining a hollow cylindrical load volume within the enclosure. The loudspeakers shown are attached to the outside of the enclosure and on the opposite external surfaces of the enclosure. A grilled cover (not shown) may cover the back of the loudspeaker to protect the loudspeaker. It will be understood that, preferably, the enclosure may completely enclose the two loudspeakers to provide greater protection.

FIG. 3 is an embodiment variant of the enclosure 1 shown in FIG. 1, where a transverse median partition 14 is used to divide the internal load volume into two parts. The transverse median partition 14 is in the median to ensure structural and functional symmetry.

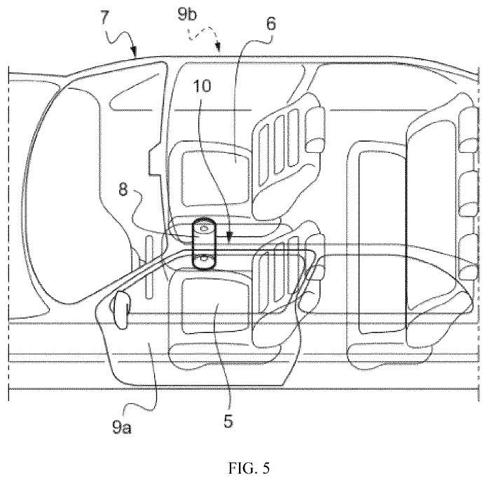

In FIG. 4, two loudspeakers 2a and 2b of the enclosure 3 are circular and arranged back to back and the illustrated enclosure 1 is here in the form of a right prism/parallelepiped prism, more precisely a cube. The hollow load volume within this enclosure is approximately shaped as a cube. The loudspeakers 2a and 2b are fixed on the inside of the enclosure, and stiffening spacers 4 in the form of columns are extended between the two loudspeakers 2a and 2b.

In the example above, the enclosure is an closed enclosure and the loudspeakers are rigidly mounted on the walls of the enclosure in a sufficiently sealed manner.

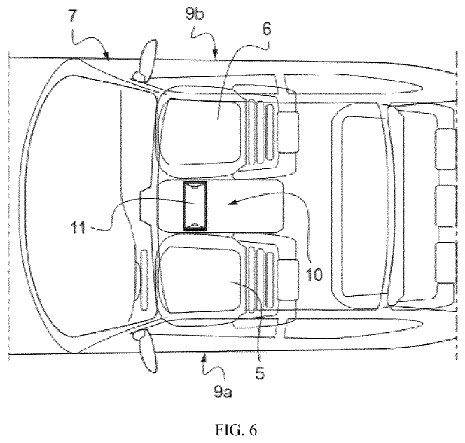

FIGS. 5-7 show two embodiments of the implementation of a device for reproducing sound in the passenger compartment 7 of a vehicle. The front part of the passenger compartment comprises, at the front, between two front side walls 9a and 9b, usually doors, a driver seat 5 and a front passenger seat 6 that are separated by a front median space 10. The device for reproducing sound used in these two embodiments includes a single enclosure. In FIG. 5, the enclosure 8 is vertically arranged in the front median space 10, a little higher than the floor of the passenger compartment 7, so that the loudspeaker at the bottom of the enclosure can “breathe/express itself”, that is, it can make the air outside the enclosure vibrate. Therefore, the axis of the loudspeaker is vertical.

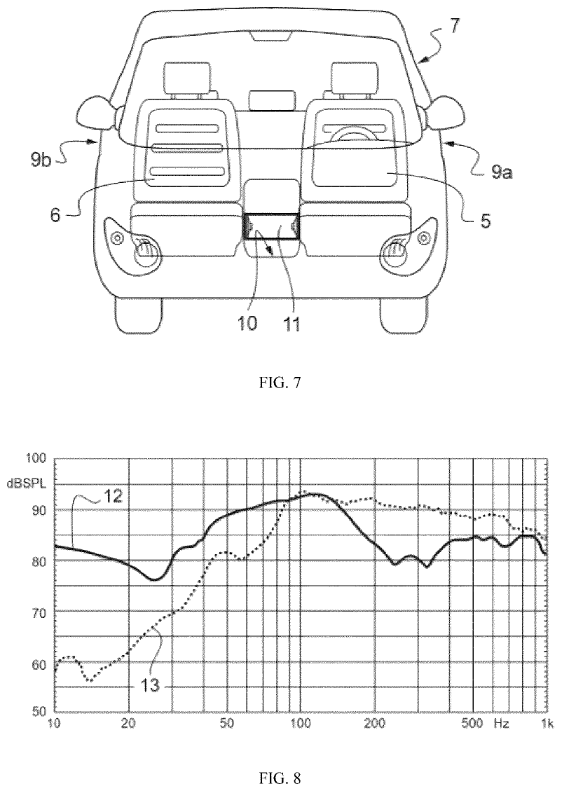

In FIGS. 6 and 7, the enclosure 11 is arranged transversely, and the axis of the enclosure can be transverse in addition to being horizontal. As above, the enclosure 11 is provided in the front median space 10. The enclosure 11 is placed on the floor of the passenger compartment 7.

In FIG. 8, the response curve 12 corresponds to the measurement of a device for reproducing sound at the driver's position in the vehicle passenger compartment. The device comprises an enclosure installed horizontally and transversely on the floor in the front median space of the passenger compartment. The response curve 13 corresponds to the measurement under semi-anechoic condition. The vertical axis of the acoustic level is measured in dB, and the frequency on the horizontal axis is measured in Hertz.

It will be understood that the present disclosure may be implemented in other ways, for example by installing the device for reproducing sound on the ceiling of the passenger compartment vertically to the front median space 10, where the axis or axes of the enclosure(s) may be vertical and/or transverse and/or longitudinal. Furthermore, an enclosure with two loudspeakers parallel to each other and aligned along the axis of the enclosure which is straight is shown. However, it is understood that, it would be equivalent if the loudspeaker axis could be bypassed, the two loudspeakers are still parallel to each other and the loudspeakers are still generally symmetrical with respect to the transverse median plane. In practice, the floor of the vehicle may comprise a protrusion along the median longitudinal or sagittal axis of the vehicle to allow a transmission shaft to pass in the underbody of the vehicle. A cylindrical load or an internal volume having a square or rectangular cross-section can be configured to match the protrusion. The two loudspeakers are fixed in parallel to two opposite ends of the load volume. The load volume is symmetrical with respect to a transverse median plane with a curved axis of the enclosure, and the plane passes through the median of the load volume. In a case where the enclosure has a curved axis, the enclosure of the enclosure or a foldable enclosure midsection, e.g., similar to TPC sheath (cable protection sheath) for buried networks, possibly with a stiffened wall but allowing folding, may still be used. Alternatively, the curved axis of the enclosure may be the original form, for example, in the case of a molded enclosure.

1. A vehicle, comprising, in a passenger compartment of the vehicle, a device for reproducing sound by loudspeakers, wherein the passenger compartment comprises seats of which, at the front of the passenger compartment, between two front side walls of the passenger compartment, a driver seat and a front passenger seat separated by a front median space comprising a vehicle center console, the reproducing sound of the device for reproducing sound covers a low-frequency spectrum in an audible spectrum to a human; the device for reproducing sound comprises a single enclosure and being installed in the center console of the vehicle; the enclosure comprises two opposite ends and, internally, a pair of loudspeakers; each of the loudspeakers comprises two opposite front and rear sides, with a face on the front side and a back on the rear side; the two loudspeakers of the enclosure are identical and are arranged on a same axis of the enclosure, symmetrically with respect to a transverse median plane of the enclosure perpendicular to the axis of the enclosure; the two loudspeakers are arranged face to face or back to back at the two opposite ends of the enclosure; the device for reproducing sound is installed in the front median space between the driver seat and the front passenger seat, and the two front side walls of the passenger compartment do not comprise a sound reproduction element for the low-frequency spectrum;
the device for reproducing sound with a single enclosure is in the form of a part of the vehicle center console, at a rear part of the center console, the enclosure of the device for reproducing sound is closed and hollow inside and comprising two openings at the two opposite ends thereof, the two loudspeakers are arranged against the openings;
the axis of the enclosure is horizontal, and the axis of the enclosure is transversely oriented, towards the driver seat and the front passenger seat; and
a volume of the enclosure allows the two loudspeakers to be used mainly around and below resonant frequencies in load of the two loudspeakers.

2. The vehicle according to claim 1, in which the low-frequency spectrum has a high cut-off frequency at −3 dB, specific to the device for reproducing sound, of 400 Hz at most.

3. The vehicle according to claim 1, wherein at least one passive filter is installed in the enclosure, and the pair of loudspeakers is powered by an audio electrical signal through the at least one passive filter.

4. The vehicle according to claim 1, comprising a multi-channel audio electronic device, comprising an audio power amplifier assembly producing an audio electrical signal, the audio power amplifier producing an audio electrical signal is intended for the device for reproducing sound to receive from upstream an audio signal to be amplified, which has been filtered by a low-pass or band-pass filter of the multi-channel audio electronic device.

5. The vehicle according to claim 4, wherein the device for reproducing sound comprises at least one terminal assembly consisting, at an output end, of an audio power amplifier and, at an input end, of a low-pass or band-pass filter, the input end receives the audio electrical signal to be amplified, and the output end is connected to at least one enclosure of the device for reproducing sound; the device for reproducing sound also receives a power supply.

6. The vehicle according to claim 1, wherein the enclosure comprises spacers or stiffening tie rods parallel to the axis of the enclosure.

7. The vehicle according to claim 1, wherein the enclosure comprises an interior sound-absorbing material, including fibrous and/or porous foam type.

8. The vehicle according to claim 1, wherein the enclosure has a shape selected from cylinder and right prism, comprising cube or rectangular parallelepiped.

9. The vehicle according to claim 1, wherein the enclosure comprises a pair of loudspeakers arranged in push-push.

10. A vehicle center console, comprising a device for reproducing sound by loudspeakers in a vehicle passenger compartment, wherein the reproducing sound covers a low-frequency spectrum in an audible spectrum to a human, the passenger compartment comprises seats, comprising, at the front of the passenger compartment, between two front side walls, a driver seat and a front passenger seat separated by a front median space receiving the vehicle center console; the device for reproducing sound comprises a single enclosure; the enclosure comprising two opposite ends and, internally, a pair of loudspeakers; each of the loudspeakers comprises two opposite front and rear sides, with a face on the front side and a back on the rear side; the two loudspeakers of the enclosure are identical and are arranged on a same axis of the enclosure and symmetrically with respect to a transverse median plane of the enclosure perpendicular to the axis of the enclosure; the two loudspeakers are arranged face to face or back to back at the two opposite ends of the enclosure; the device for reproducing sound is arranged in a rear part of the center console so that the device for reproducing sound can be installed in the front median space between the driver seat and the front passenger seat; the enclosure of the device for reproducing sound is closed and hollow internally and comprising two openings at the two opposite ends thereof, the two loudspeaker are arranged against the openings; the axis of the enclosure is horizontal, and the axis of the enclosure is transversely oriented, and the center console is therefore configured to obtain the vehicle according to claim 1.
